(19) United States
(12) Patent Application Publication
(10) Pub. No.: US 2024/0296229 A1
(43) Pub. Date: Sep. 5, 2024

(54) SYSTEMS AND METHODS FOR BOOTSTRAPPED PROVISIONING OF A DEVICE

(71) Applicant: DELL PRODUCTS L.P., Round Rock, TX (US)

(72) Inventors: Pulikode Mukundan GOVIND, Singapore (SG); Nyi Nyi THWIN, Singapore (SG)

(73) Assignee: DELL PRODUCTS L.P., Round Rock, TX (US)

(21) Appl. No.: 18/178,334

(22) Filed: Mar. 3, 2023

(51) Int. Cl. G06F 21/57; G06F 21/71

(52) U.S. Cl. CPC G06F 21/575; G06F 21/71

(57) ABSTRACT

The device initialization (DI) process involves embedding the ownership and manufacturing credentials into the new device. Among other things, this device initialization process establishes the first in a chain for creating an ownership voucher with which to transfer ownership of the device. Presented herein are embodiments that facilitate automated device initialization and associated provisioning of devices, such as FDO devices. In one or more embodiments, a transient bootstrap execution environment (BEE) (or device initialization execution environment (DIEE)) is used on the device. Embodiments may be utilized to perform device initialization without additional setup costs and complexity at the manufacturing location. Furthermore, significant modifications to existing manufacturing process can also be avoided.

### BACKGROUND

### A. Technical Field

The present disclosure relates generally to information handling systems, including but not limited to, Internet-of-Things (IoT) devices. More particularly, the present disclosure relates to embedding ownership and manufacturing credentials into a device.

### B. Background

The subject matter discussed in the background section shall not be assumed to be prior art merely as a result of its mention in this background section. Similarly, a problem mentioned in the background section or associated with the subject matter of the background section should not be assumed to have been previously recognized in the prior art. The subject matter in the background section merely represents different approaches, which in and of themselves may also be inventions.

As the value and use of information continues to increase, individuals and businesses seek additional ways to process and store information. One option available to users is information handling systems. An information handling system (or devices) generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use, such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As the size, cost, and functionality of information handling devices have diversified, information handling devices are used in numerous places. While the proliferation of technology has made modern life easier and/or better, there are some associated issues. One such issue is related to security. Malicious actors may attempt to gain access to devices or to networks via compromised or rogue devices. Accordingly, security aspects have been developed, and continue to evolve, to help secure devices and networks.

The FIDO™ (“Fast IDentity Online”) Alliance is an association formed by various businesses that seeks to develop strong authentication protocols to help reduce issues related to authentication and security. One such protocol—FDO Device Onboarding—is related to what is called “onboarding,” in which a device is securely added to a network (or platform). Currently, the onboarding process is typically performed manually by a technician or administrator. As with many manual processes, it can be slow, costly, subject to errors, and insecure. Furthermore, with the proliferation of devices, such as in the case of Internet-of-Things (IoT) devices, manual processing become feasibly impractical. Thus, the FDO Device Onboarding specification is intended to automate the process of onboarding. While the FDO Device Onboarding process proposed by the FIDO™ Alliance is helpful, there are problems.

The existing FDO specification assumes the existence of an out-of-box, external “manufacturing service” that creates a FDO Ownership Voucher and performs the initial provisioning of the device. This process involves creating, configuring, and maintaining an always online server, which might not be convenient in manufacturing environments without the required IT infrastructure or expertise. Such a requirement also may not be feasible in situations of low volume manufacturing, which tend to be very sensitive to costs. Furthermore, this process also introduces additional steps to an existing manufacturing process, which results in extra effort, increased complexity of the overall process, added costs, and increased opportunity for potential production delays.

Accordingly, it is highly desirable to find new, more efficient ways to perform the initial provisioning of a device.

### BRIEF DESCRIPTION OF THE DRAWINGS

References will be made to embodiments of the disclosure, examples of which may be illustrated in the accompanying figures. These figures are intended to be illustrative, not limiting. Although the accompanying disclosure is generally described in the context of these embodiments, it should be understood that it is not intended to limit the scope of the disclosure to these particular embodiments. Items in the figures may not be to scale.

FIG. 1 (“FIG. 1”) depicts a set of stages or steps that are part of an onboarding process, according to embodiments of the present disclosure.

FIG. 2 depicts a workflow for performing device initialization, according to embodiments of the present disclosure.

FIG. 3 illustrates a workflow process, according to embodiments of the present disclosure.

FIG. 4 depicts a methodology for performing device initialization or provisioning, according to embodiments of the present disclosure.

FIG. 5 depicts an example of an additional security measure that may be added to embodiments of device initialization/provisioning, according to embodiments of the present disclosure.

FIG. 6 depicts an example of an additional security measure that may be added to embodiments of device initialization/provisioning, according to embodiments of the present disclosure.

FIG. 7 depicts a simplified block diagram of an information handling system, according to embodiments of the present disclosure.

FIG. 8 depicts an alternative block diagram of an information handling system, according to embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system/device, or a method on a tangible computer-readable medium.

Components, or modules, shown in diagrams are illustrative of exemplary embodiments of the disclosure and are meant to avoid obscuring the disclosure. It shall be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgement, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. The terms “include,” “including,” “comprise,” “comprising,” and any of their variants shall be understood to be open terms, and any examples or lists of items are provided by way of illustration and shall not be used to limit the scope of this disclosure.

A service, function, or resource is not limited to a single service, function, or resource; usage of these terms may refer to a grouping of related services, functions, or resources, which may be distributed or aggregated. The use of memory, database, information base, data store, tables, hardware, cache, and the like may be used herein to refer to system component or components into which information may be entered or otherwise recorded. The terms “data,” “information,” along with similar terms, may be replaced by other terminologies referring to a group of one or more bits, and may be used interchangeably. The terms “packet” or “frame” shall be understood to mean a group of one or more bits. The term “frame” shall not be interpreted as limiting embodiments of the present invention to Layer 2 networks; and, the term “packet” shall not be interpreted as limiting embodiments of the present invention to Layer 3 networks. The terms “packet,” “frame,” “data,” or “data traffic” may be replaced by other terminologies referring to a group of bits, such as “datagram” or “cell.” The words “optimal,” “optimize,” “optimization,” and the like refer to an improvement of an outcome or a process and do not require that the specified outcome or process has achieved an “optimal” or peak state.

It shall be noted that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims. Each reference/document mentioned in this patent document is incorporated by reference herein in its entirety.

It shall also be noted that although embodiments described herein may be within the context of device initialization related to FDO specification, aspects of the present disclosure are not so limited. Accordingly, the aspects of the present disclosure may be applied or adapted for use in other contexts.

### A. General Background and Overview

### 1. Device Onboarding Overview

As noted above, the use of information handling systems (which may also be referred to herein as devices) has exploded over the last few years and appears to be growing. As part of the deployment of a device, the device typically must be installed and configured. The process of installing and configuring a device may be referred to as “onboarding.” Device onboarding typically involves installation of the physical device and setup of credentials so that it can securely communicate with its target cloud or platform. FIDO Alliance developed a Secure Device Onboarding (SDO) process, which is known as the FDO specification.

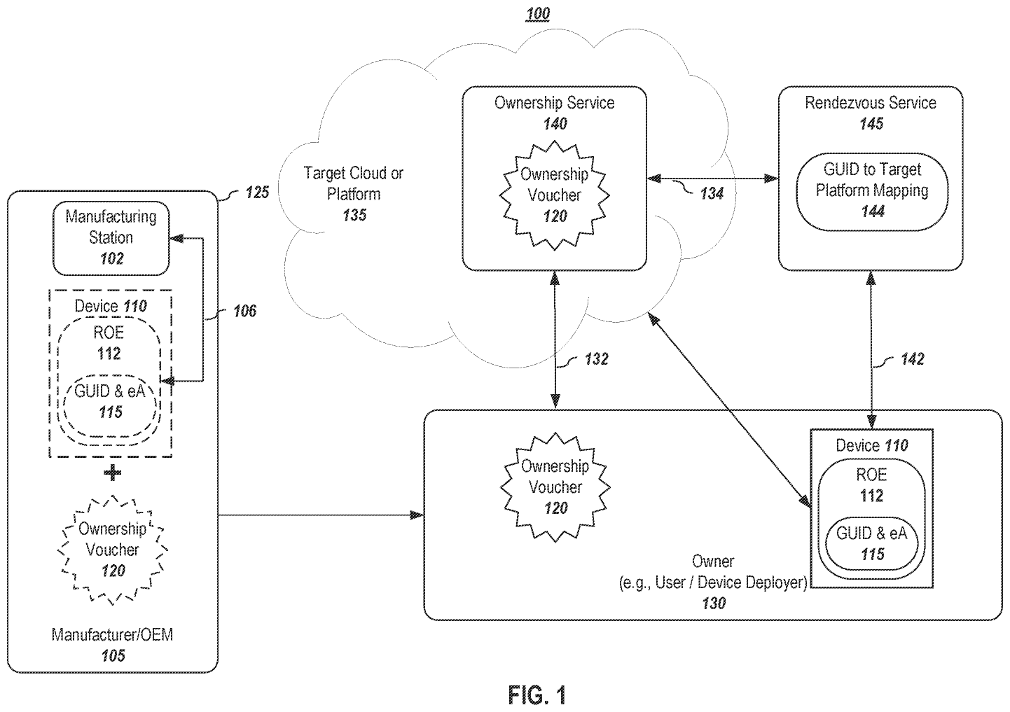

FIG. 1 depicts a set of stages or steps that are part of a general onboarding process, according to embodiments of the present disclosure. The first stage, the manufacturing process 125, involves a manufacturer or original equipment manufacturer (OEM) building a device 110. The device 110 may include a client and a root of trust (RoT) key that to uniquely identifies the device. The RoT may or use a cryptographic key or keys built into a component of the device, such as a trusted platform module (TPM). In the depicted embodiment in FIG. 1, the device is configured to include a GUID (a globally unique identifier) and a device attestation key (eA) 115. It should be noted that one or more additional credentials may also be included with the device along with an address or addresses that is used later as part of the onboarding process. Finally, a digital proof of ownership, which is depicted in FIG. 1 as the ownership voucher 120, is associated with the device. The ownership voucher 120 may be implemented as a self-protected digital document and is used by the owner (e.g., user/customer/device deployer 130) of the device to identify itself later in the onboarding process.

In one or more embodiments, the ownership voucher may comprise a number of fields with data used to identify the associated device. For example, in one or more embodiments, an ownership voucher header may comprise the following (it should be noted that fewer or additional fields and data may be included):

| | | |
|---|---|---|
| OVHProtVer: | protver | ;; protocol version |
| OVGuid: | GUID | ;; GUID |
| OVRVInfo: | Rendezvous Info | ;;rendezvous instructions |
| OVDeviceInfo: | tstr | ;; DeviceInfo |
| OVPubKey: | PublicKey, | ;; mfg public key |

| | |
|---|---|
| OVDevCertChainHash: | OVDevCertChainHashORNull |

The device may be placed in an inactive state and shipped to an end-user, who then may activate and take ownership of the device.

For example, the device is shipped to the owner/user/device deployer 130, and the ownership voucher 120 is transmitted or sent to the owner/user/device deployer 130.

The next step or phase (132) involves the device owner 130 sending the ownership voucher 120 to a cloud/platform 135, which may include an ownership service 140 that stores the ownership voucher 120. The ownership service 140 registers 134 the ownership voucher 120 with a rendezvous server or service (RV), which acts like a DNS (domain name system) service.

User deployment of the device is the next major phase, which involves the user connecting the device to a network. Following boot-up, the device 110 contacts the rendezvous service 145 that was programmed into the device 110 during manufacturing. The device 110 identifies (142) itself to the rendezvous service 145. For example, as part of the ownership service registering with the rendezvous service 145 as discussed in the prior paragraph, the rendezvous service 145 may receive the GUID 144 for the device 110. The rendezvous service 145, seeing the device in its list of GUIDs, matches the device to its target cloud/platform and provides an address for the target cloud/platform 135 (or which may be the ownership service 140) to the device 110. It should be noted that a device may be configured to contact any of a plurality of rendezvous servers, including on-premise and/or cloud rendezvous services.

Based on the information provided by the rendezvous service 145, the device contacts the cloud/platform (e.g., cloud 135 or ownership service 140). The ownership service 140 and the device 110 perform mutual attestations to confirm the validity of each other. For example, the device uniquely identifies itself to the cloud/platform, and the cloud/platform uses the ownership voucher to confirm its validity to the device.

Following successful mutual attestations, a secured, encrypted tunnel may be created between the device and the cloud/platform. For example, the cloud/platform 135 or 140 may download over the encrypted tunnel one or more credentials or software agents for operating and managing the device.

Note that one benefit of such a process flow is that it allows for “late binding.” Late binding allows a user to choose its target cloud or on-premises server late in the supply chain.

### 2. Typical Device Initialize (DI) Processes

Of particular interest for the current patent document is the device initialization (or provisioning) process or protocol. As illustrated above, device initialization is typically performed by the manufacturer when a new device (or end point) is made. Before a device can be onboarded, it must be provisioned to embed the ownership and manufacturing credentials into the device. This process may be referred to as Device Initialization (DI). Also, a Trust-on-First-Use (TOFU) model is used. It is preferred that write-once memory is used to ensure the device is not later erased or reprogrammed with alternate credentials. The DI protocol or process ensures that the initial ownership voucher (OV) contains a means to trust the device (e.g., via an embedded devices certificate chain or Intel® Enhanced Privacy ID).

The device initialization process requires or assumes that the device is initialized and configured in a secure environment at the factory. Specifically, the existing FDO specification assumes the existence of an out-of-box, external “manufacturing service” that creates a FDO ownership voucher and performs the initial provisioning of the device. A device initialize process assume that the process will be performed in a safe environment. To create the safe environment, this process involves creating, configuring, and maintaining an always online server, which might not be convenient in manufacturing environments without the required IT infrastructure or expertise. Such a requirement also may not be feasible in situations of low volume manufacturing, which tend to be very sensitive to costs. Furthermore, this process also introduces additional steps to an existing manufacturing process, which results in extra effort, increased complexity of the overall process, added costs, and increased opportunity for potential production delays.

The DI process involves interaction between two key actors or elements, which are graphically depicted in FIG. 1 as the manufacturer 105 and the device 110 blocks. As illustrated in FIG. 1, the device 110 comprises as restricted operation environment (ROE) 112 that interfaces with a manufacturing station 102 to perform the device initialization process. In one or more embodiments, the output of a device initialization process is a digital document comprising a device ownership voucher, which can then be used to establish device ownership during a later phase (e.g., a TO2 phase which involves the device contacting the owner, establishes trust, and then performs ownership transfer.

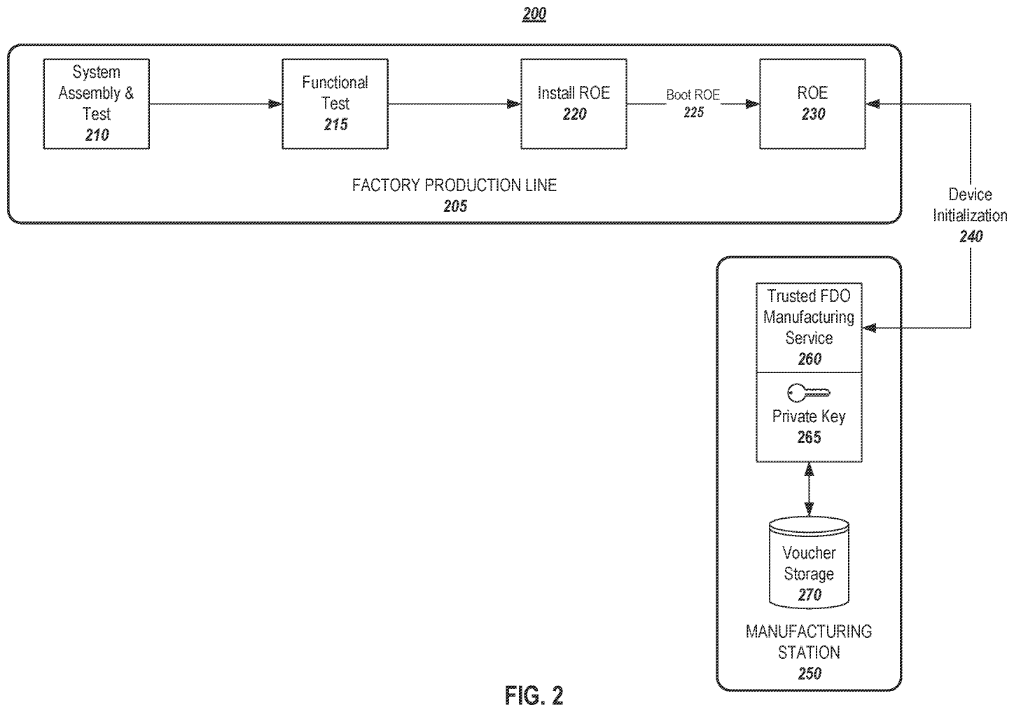

Turning to FIG. 2, depicted is a typical workflow for performing device initialization, according to embodiments of the present disclosure. A manufacturer typically has a factory production line 205 that involves several steps or stages. As depicted, a device is first assembled. A system assembly and test phase 210 may include subcomponent and device assembly and testing, such as hardware tests. The next phase may include functional testing 215 in which all functional features or a subset of features available on the device are tested. Next, in the depicted embodiments, the device goes through a restricted operating environment (ROE) installation phase 220, in which an ROE (a possibly other software) is installed.

Finally, the system runs the ROE to perform a device initialization process that involves interacting with a manufacturing station 250. The ROE communicates 240 with an external manufacturing station 250 that is usually running over a LAN (local area network) or similar network to carry out the DI. The manufacturing station 250 usually contains an application capable of driving the DI process and creating an initial ownership voucher. For convenience, this application may be referred to as a “trusted manufacturing service” or trusted FDO manufacturing service 260 (although it should be noted that embodiments herein are not limited to just FDO implementations). To sign the ownership voucher, the manufacturing service 260 has access to a key pair for device ownership, which is used to create device credentials in the device and the ownership voucher. This key pair need not specifically identify the manufacturer and may be changed from time to time, so long as the device credential refers to the same key pair as the ownership voucher for that device. The manufacturing service 260 may also have access to a device description string, which may be configured by the manufacturer. The manufacturing service 260 accesses the device ROE. The DI process may conclude with the manufacturing service 260 having information and credentials to create an ownership voucher for the device or has the ownership voucher itself, and the device has ownership and manufacturer credentials, which may be stored in its ROE. Preferably only the device ROE software has access to these credentials and the credentials are protected against modification (at least by non-authorized entities).

The device may have a GUID (globally unique ID) that may be used to identify it to its new owner. This GUID is also known to the manufacturing service 260 and may be included in the ownership voucher. Specifically, the GUID may be used to identify the device (i.e., be visible to the owner on a label or invoice for the device). The GUID may be used for one transfer of ownership; a new GUID may be used to a subsequent transfer.

As endpoint devices are provisioned, new vouchers are created and stored by the manufacturing service 260 inside a datastore 270. In FIG. 2, the private key 265 and datastore 270 are depicted at the manufacturing station 250 but may be housed (securely) elsewhere.

The initial assembly and test phases are typically part of existing factory workflows for producing devices, such as IoT endpoints, and the remaining phases are additional steps required for device initialization.

As noted previously, the typical DI workflow has significant disadvantages. It requires an external manufacturing station that drives the DI process. This external system consumes additional IT infrastructure, maintenance, and support. It introduces additional steps that require some non-trivial modifications to the existing manufacturing workflow. Also, these added steps and equipment can result in significant penalties of cost and time in manufacturing environments.

### 3. Device Initialization Embodiments

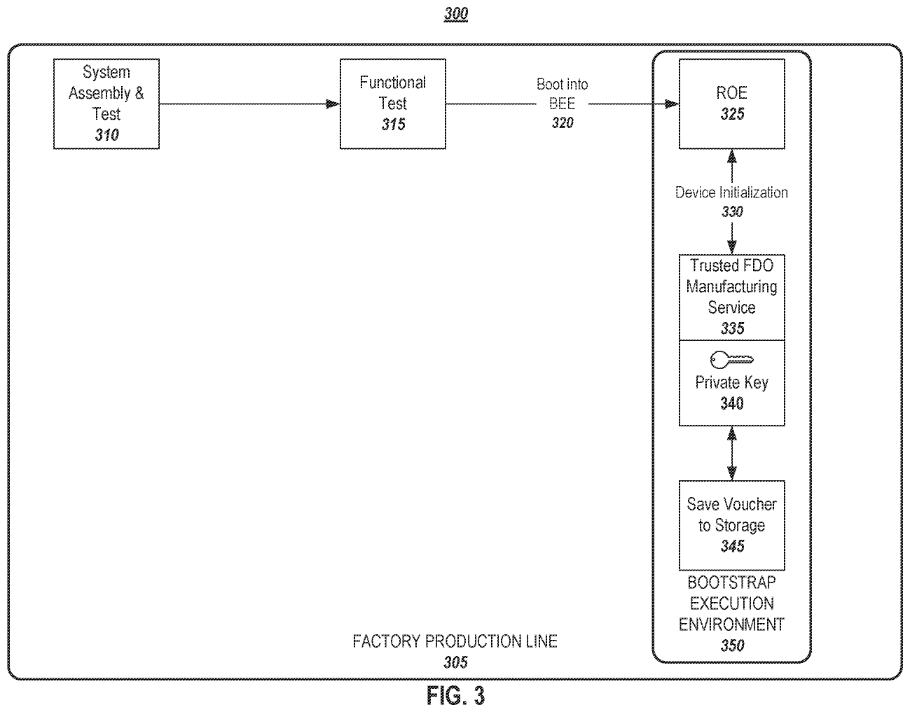

To reduce or eliminate these disadvantages, embodiments introduce a “Bootstrap Execution Environment (BEE)” or “Device Initialization Execution Environment (DIEE),” which contains the functionality required to provision the device, install the ROE, and perform DI. In one or more embodiments, this BEE/DIEE may be a transient environment (i.e., it is never installed) that the endpoint device boots into once after the functional tests. FIG. 3 illustrates a workflow process, according to embodiments of the present disclosure.

As illustrated in FIG. 3, in one or more embodiments, a manufacturer's factory production line 305 includes typical phases, such as a system assembly and test phase 310 and functional testing phase 315. However, unlike the traditional approach of the prior section, in the depicted embodiments, the device is booted 320 into a BEE/DIEE environment 350.

The BEE/DIEE may be a bootable software package (e.g., an ISO image) that contains a version of the ROE and the manufacturing service used to generate an ownership voucher (e.g., a FDO Ownership Voucher). In one or more embodiments, the BEE/DIEE may be booted via a USB (universal serial bus) or other removable media attached to the device, or may be accessed by the device via a wired or wireless connection.

As depicted in FIG. 3, the BEE/DIEE environment 350 includes the device's ROE 325 and a manufacturing service component 355. These elements are able to communicate with each other in order to perform DI 330. Similar to the typical approach, the DI process generates an ownership voucher (and additional credentials or data), in which at least some of the information is saved to a storage 345, which may be within the BEE/DIEE, or may be housed elsewhere.

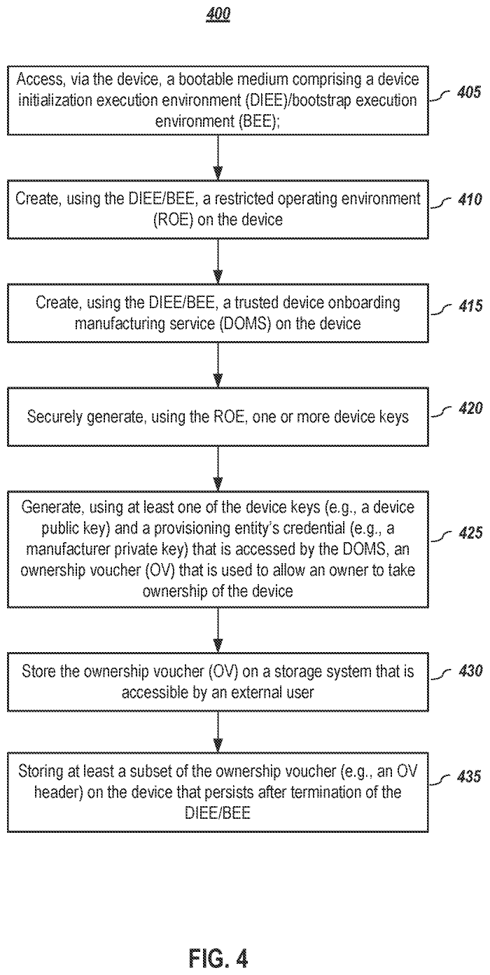

FIG. 4 depicts a methodology for performing device initialization, according to embodiments of the present disclosure. In one or more embodiments, the device is provided access (405) to a bootable medium comprising a device initialization execution environment (DIEE)/bootstrap execution environment (BEE). The access may be provided via a pluggable device (e.g., USB), compact disk (CD), or via some connection to a computer-readable medium.

In one or more embodiments, once the BEE/DIEE boots, using the DIEE/BEE, it creates (410 & 415) a restricted operating environment (ROE) and a trusted device onboarding manufacturing service (DOMS) on the device. The ROE and DOMS may each be internal applications.

The ROE and DOMS communicate with each other within the DIEE/BEE (e.g., via an internal socket) and may perform DI on the device as typically performed. In one or more embodiments, using the ROE, one or more device keys are securely generated (420). Using at least one of the device keys (e.g., a device public key) and a provisioning entity's credential (e.g., a manufacturer private key) that is accessed by the DOMS, an ownership voucher (OV) that is used to allow an owner to take ownership of the device is generated (425). That is, the DOMS signs the ownership voucher (OV) with a private key stored within the DIEE/BEE or that is accessible to the DIEE/BEE (e.g., via a hardware security module that is physically attached to the device or via a secure connection to the private key stored in an external key-vault). Once generated, the ownership voucher (OV) may be stored (430) on a storage system that is accessible by an external user or users. Examples of such storage include but are not limited to USB/disk storage connected to the device, an external server (e.g., FTP (file transfer protocol) or SMB (small-medium business) server), or an external storage.

Also, in one or more embodiments, at least a subset of the ownership voucher (e.g., an OV header) is stored (435) on the device so as to persist after termination of the DIEE/BEE. In one or more embodiments, the device may retain, after reboot following removal of access to the DIEE/BEE, a device credential, which comprises at least one of the device keys and at least the subset of the ownership voucher on the device; however, in one or more embodiments, the device does not retain at least the device onboarding manufacturing service on the device following reboot. That is, once access to the DIEE/BEE has been removed and the device reboots, in one or more embodiments, at least the DOMS internal application does not exist on the device. The device may load its operating software and function as designed when deployed by an owner/end-user.

In one or more embodiments, the DIEE/BEE may be designed or configured to execute all the above-mentioned steps automatically. Such an implementation means that the DI process adds only a very simple one-step process to the manufacturing workflow. It also dramatically reduces the resource costs, as there are no separate computing devices required to be configured, used, and maintained.

### 4. Additional Embodiments

Because some embodiments make the manufacturing process more mobile (e.g., using a USB for the DIEE/BEE image) as opposed to an air-gapped factory environment, there may be opportunities for potential misuse. Accordingly, it shall be noted that embodiments may include implementing one or more additional security features-including but not limited to, utilizing one or more passwords, configuring biometric authentication, adding additional credentials, using tamperproof media, logging/recording activities, etc.

For example, one or more of the following hardening measures may be included. In one or more embodiments, to prevent modifications of the DIEE/BEE image, it may be generated using an encryption-at-rest solutions, such as dm-crypt/LUKS, with the key either stored in the kernel image or acquired at runtime from an external authentication server. In one or more embodiments, to authenticate users/manufacturers of the system, an external authentication server may be employed to validate user credentials and keep a record of the number of devices being provisioned. In one or more embodiments, local authentication may be implemented using a license key/password mechanism.

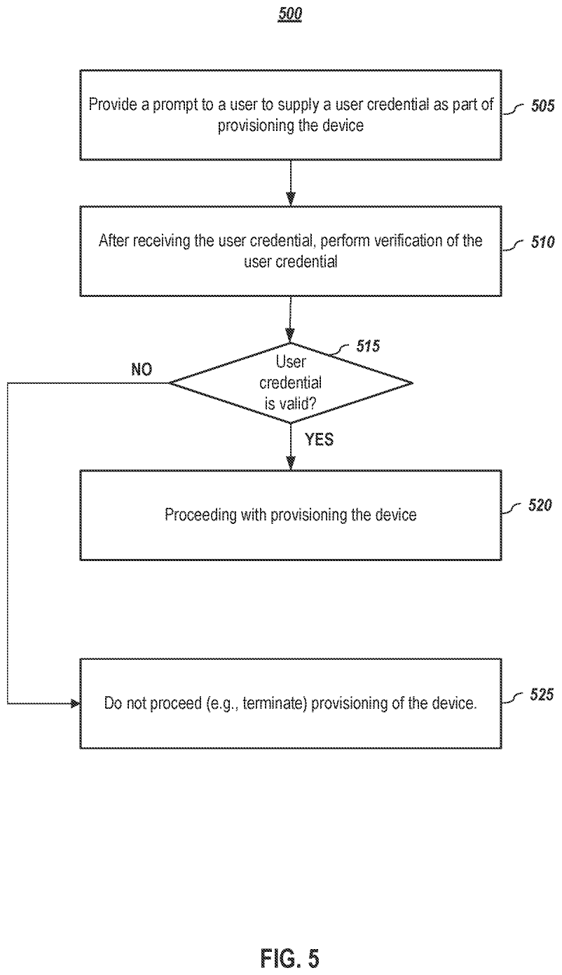

FIG. 5 depicts an example of an additional security measure that may be added to the DI provisioning process, according to embodiments of the present disclosure. In one or more embodiments, as an initial part of the DIEE/BEE boot-up or as part of a secure BIOS-type device loading, a prompt is provided (505) to a user to supply a user credential. After receiving the user credential, the user credential is verified/authenticated (510/515). Responsive to the user credential being verified, provisioning the device according to the DI may proceed (520). However, responsive to the user credential not being verified, the process of provisioning of the device does not proceed (525). In such a case, the process may perform one or more of the following: terminate access to the device, log the attempt and other data related to the attempt, notify an admin of the failed attempt, and lock the device.

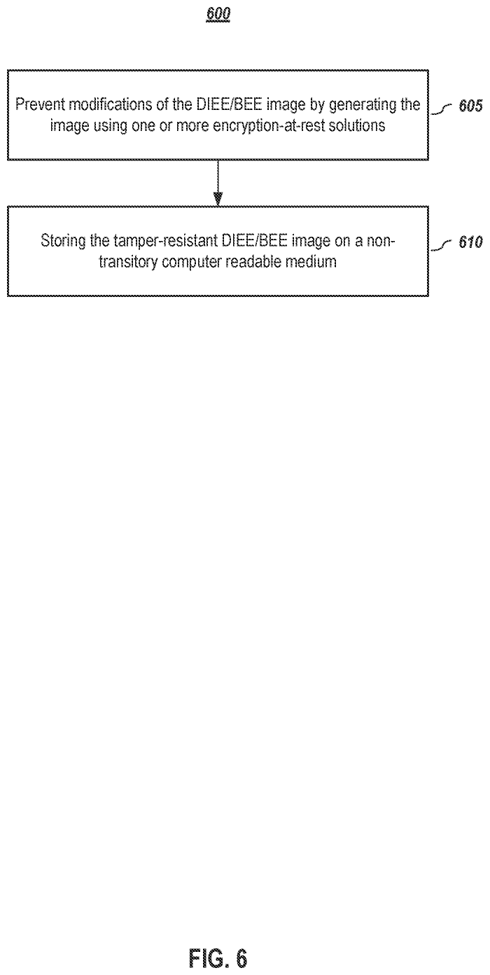

FIG. 6 depicts an example of an additional security measure that may be added to the DI process, according to embodiments of the present disclosure. In one or more embodiments, to prevent modifications of the DIEE/BEE image, the image may be generated (605) using one or more encryption-at-rest solutions. Following generation of the DIEE/BEE image, the tamper-resistant DIEE/BEE image may be stored (610) on a non-transitory computer readable medium, which may further be tamper-proof/tramper-resistant (e.g., a read only media).

Additionally, the DIEE/BEE image media, such as a USB device, may be stored in a secure location with limited access and logging of access and use. In one or more embodiments, the DIEE/BEE image media may be single use. For example, following completion of the DI process, the media may be securely erased so that it cannot be reused if obtained by a malicious actor. A new media would need to be obtained to provision another device.

One skilled in the art shall recognize that one or more additional hardening measures may be implemented to protect against specific or general threats.

### B. System Embodiments

In one or more embodiments, aspects of the present patent document may be directed to, may include, or may be implemented on one or more information handling systems (or computing systems). An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smart phone, phablet, tablet, etc.), smart watch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read only memory (ROM), and/or other types of memory. Additional components of the computing system may include one or more drives (e.g., hard disk drives, solid state drive, or both), one or more network ports for communicating with external devices as well as various input and output (I/O) devices. The computing system may also include one or more buses operable to transmit communications between the various hardware components.

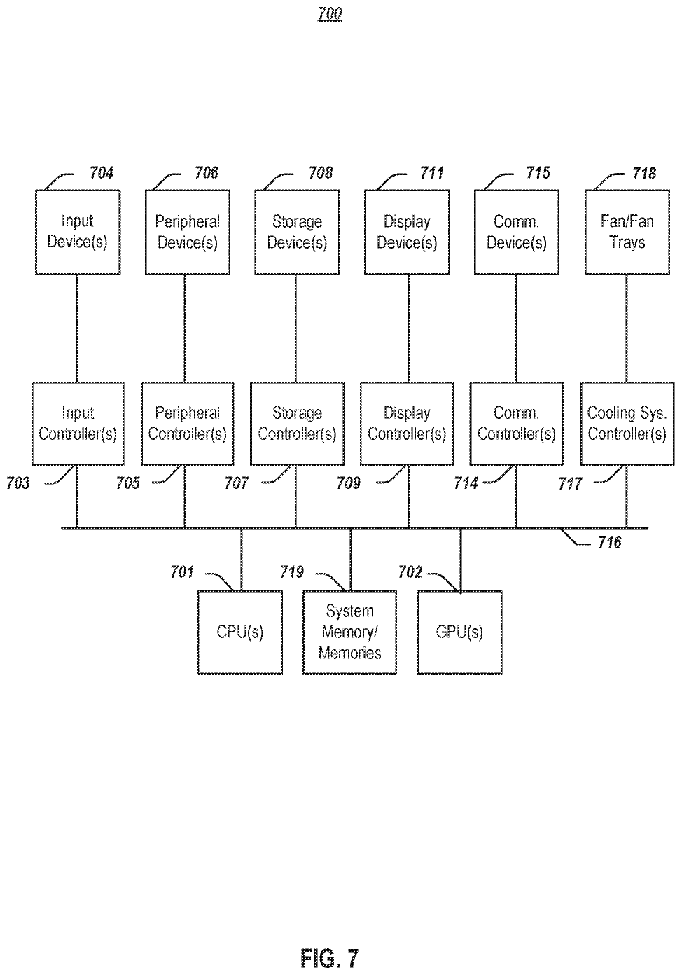

FIG. 7 depicts a simplified block diagram of an information handling system (or computing system), according to embodiments of the present disclosure. It will be understood that the functionalities shown for system 700 may operate to support various embodiments of a computing system—although it shall be understood that a computing system may be differently configured and include different components, including having fewer or more components as depicted in FIG. 7.

As illustrated in FIG. 7, the computing system 700 includes one or more CPUs 701 that provides computing resources and controls the computer. CPU 701 may be implemented with a microprocessor or the like and may also include one or more graphics processing units (GPU) 702 and/or a floating-point coprocessor for mathematical computations. In one or more embodiments, one or more GPUs 702 may be incorporated within the display controller 709, such as part of a graphics card or cards. The system 700 may also include a system memory 719, which may comprise RAM, ROM, or both.

A number of controllers and peripheral devices may also be provided, as shown in FIG. 7. An input controller 703 represents an interface to various input device(s) 704, such as a keyboard, mouse, touchscreen, stylus, microphone, camera, trackpad, display, etc. The computing system 700 may also include a storage controller 707 for interfacing with one or more storage devices 708 each of which includes a storage medium such as magnetic tape or disk, or an optical medium that might be used to record programs of instructions for operating systems, utilities, and applications, which may include embodiments of programs that implement various aspects of the present disclosure. Storage device(s) 708 may also be used to store processed data or data to be processed in accordance with the disclosure. The system 700 may also include a display controller 709 for providing an interface to a display device 711, which may be a cathode ray tube (CRT) display, a thin film transistor (TFT) display, organic light-emitting diode, electroluminescent panel, plasma panel, or any other type of display. The computing system 700 may also include one or more peripheral controllers or interfaces 705 for one or more peripherals 706. Examples of peripherals may include one or more printers, scanners, input devices, output devices, sensors, and the like. A communications controller 714 may interface with one or more communication devices 715, which enables the system 700 to connect to remote devices through any of a variety of networks including the Internet, a cloud resource (e.g., an Ethernet cloud, a Fibre Channel over Ethernet (FCoE)/Data Center Bridging (DCB) cloud, etc.), a local area network (LAN), a wide area network (WAN), a storage area network (SAN) or through any suitable electromagnetic carrier signals including infrared signals. As shown in the depicted embodiment, the computing system 700 comprises one or more fans or fan trays 718 and a cooling subsystem controller or controllers 717 that monitors thermal temperature(s) of the system 700 (or components thereof) and operates the fans/fan trays 718 to help regulate the temperature.

In the illustrated system, all major system components may connect to a bus 716, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable media including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

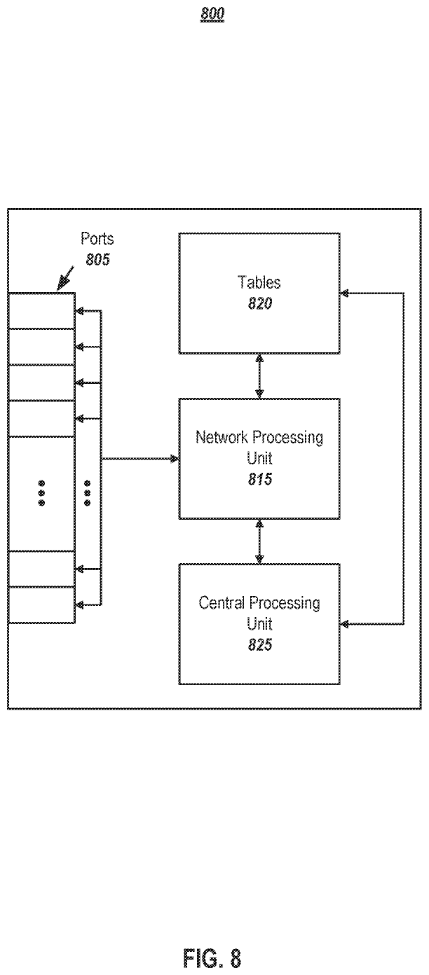

FIG. 8 depicts an alternative block diagram of an information handling system, according to embodiments of the present disclosure. It will be understood that the functionalities shown for system 800 may operate to support various embodiments of the present disclosure although it shall be understood that such system may be differently configured and include different components, additional components, or fewer components.

The information handling system 800 may include a plurality of I/O ports 805, a network processing unit (NPU) 815, one or more tables 820, and a CPU 825. The system includes a power supply (not shown) and may also include other components, which are not shown for sake of simplicity.

In one or more embodiments, the I/O ports 805 may be connected via one or more cables to one or more other network devices or clients. The network processing unit 815 may use information included in the network data received at the node 800, as well as information stored in the tables 820, to identify a next device for the network data, among other possible activities. In one or more embodiments, a switching fabric may then schedule the network data for propagation through the node to an egress port for transmission to the next destination.

Aspects of the present disclosure may be encoded upon one or more non-transitory computer-readable media with instructions for one or more processors or processing units to cause steps to be performed. It shall be noted that the one or more non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that have computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as compact discs (CDs) and holographic devices; magneto-optical media; and hardware devices that are specially configured to store or to store and execute program code, such as ASICs, PLDs, flash memory devices, other non-volatile memory devices (such as 3D XPoint-based devices), ROM, and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A processor-implemented method for provisioning a device comprising:
accessing a bootable medium comprising a device initialization execution environment (DIEE);
responsive to the DIEE being booted on the device:
generating one or more device keys for the device;
generating, using at least one of the device keys and a provisioning entity's credential that is accessed by the DIEE, an ownership voucher that is used to allow an owner to take ownership of the device; and
storing the ownership voucher on a storage system that is accessible by an external user.

2. The processor-implemented method of claim 1 further comprising:
storing at least a subset of the ownership voucher on the device, in which the at least a subset of the ownership voucher persists on the device even after termination of the DIEE.

3. The processor-implemented method of claim 1 wherein the bootable medium comprises an image of the device initialization execution environment (DIEE).

4. The processor-implemented method of claim 3 wherein the image of the DIEE was generated using an encryption-at-rest implementation to prevent modifications of the image.

5. The processor-implemented method of claim 1 further comprising the step of:
providing a prompt to a user to supply a user credential as part of provisioning the device;
responsive to receiving the user credential, verifying the user credential;
responsive to the user credential being valid, proceeding with provisioning the device; and
responsive to the user credential not being valid, not proceeding with provisioning the device.

6. The processor-implemented method of claim 1 wherein the step of generating one or more device keys for the device comprises the step of:
creating a restricted operating environment on the device, wherein the one or more device keys for the device are generated using the restricted operating environment.

7. The processor-implemented method of claim 6 wherein the step of generating an ownership voucher for the device comprises the step of:
creating a device onboarding manufacturing service on the device that communicates with the restricted operating environment to generate the ownership voucher for the device.

8. The processor-implemented method of claim 7 further comprising:
configuring the device so that, after removal of the bootable medium and rebooting of the device, the device retains a device credential comprising at least one of the device keys and the at least the subset of the ownership voucher on the device but does not retain at least the device onboarding manufacturing service on the device.

9. A non-transitory computer-readable medium or media comprising one or more sequences of instructions which, when executed by at least one processor of a device, causes steps for provisioning or initializing the device comprising:
creating a restricted operating environment on the device;
generating one or more device keys for the device using the restricted operating environment;
creating a device onboarding manufacturing service on the device that communicates with the restricted operating environment;
generating, using at least one of the device keys and a provisioning entity's credential that is accessed by the device onboarding manufacturing service, an ownership voucher that is used to allow an owner to take ownership of the device; and
storing the ownership voucher on a storage system that is accessible by an external user.

10. The non-transitory computer-readable medium or media of claim 9 further comprising one or more sequences of instructions which, when executed by at least one processor, causes steps to be performed comprising:
storing at least a subset of the ownership voucher on the device, in which the at least a subset of the ownership voucher persists on the device.

11. The non-transitory computer-readable medium or media of claim 9 further comprising one or more sequences of instructions which, when executed by at least one processor, causes steps to be performed comprising:
following provisioning the device, causing the device:
to be configured to remove at least the device onboarding manufacturing service; and
to retain on the device a device credential comprising at least one of the device keys and at least the subset of the ownership voucher.

12. The non-transitory computer-readable medium or media of claim 9 wherein the one or more sequences of instructions for provisioning the device are contained in a bootable image on the non-transitory computer-readable medium or media.

13. The non-transitory computer-readable medium or media of claim 12 wherein the bootable image was generated using an encryption-at-rest implementation to prevent modifications of the bootable image.

14. The non-transitory computer-readable medium or media of claim 9 further comprising one or more sequences of instructions which, when executed by at least one processor, causes steps to be performed comprising:
providing a prompt to a user to supply user credential as part of provisioning the device;
responsive to receiving the user credential, verifying, using an authentication service, the user credential;
responsive to the user credential being valid, proceeding with provisioning the device; and
responsive to the user credential not being valid, not proceeding with provisioning the device.

15. A device comprising:
one or more processors; and
a non-transitory computer-readable medium or media comprising one or more sets of instructions which, when executed by at least one of the one or more processors, causes steps to be performed comprising:
accessing a bootable medium comprising a device initialization execution environment (DIEE);
responsive to the DIEE being booted on the device:
generating one or more device keys for the device;
generating, using at least one of the device keys and a provisioning entity's credential that is accessed by the DIEE, an ownership voucher that is used to allow an owner to take ownership of the device; and
storing the ownership voucher on a storage system that is accessible by an external user; and
storing at least a subset of the ownership voucher on the device.

16. The device of claim 15 wherein the bootable medium comprises an image of the device initialization execution environment (DIEE).

17. The device of claim 16 wherein the image of the DIEE has been generated using an encryption-at-rest implementation to prevent modifications of the image.

18. The device of claim 15 wherein the step of generating one or more device keys for the device comprises the step of:
creating a restricted operating environment on the device, wherein the one or more device keys for the device are generated using the restricted operating environment.

19. The device of claim 18 wherein the step of generating an ownership voucher for the device comprises the step of:
creating a device onboarding manufacturing service on the device that communicates with the restricted operating environment to generate the ownership voucher for the device.

20. The device of claim 19 wherein the non-transitory computer-readable medium or media further comprises one or more sequences of instructions which, when executed by at least one of the one or more processors, causes steps to be performed comprising:
configuring the device so that, after removal of the bootable medium and rebooting of the device, the device retains a device credential comprising at least one of the device keys and at least the subset of the ownership voucher on the device but does not retain at least the device onboarding manufacturing service on the device.
